(19) United States
(12) Patent Application Publication
(10) Pub. No.: US 2026/0138718 A1
(43) Pub. Date: May 21, 2026

(54) System for an Oar Determining the Rowing Force During an Oar Stroke

(71) Applicant: Mandanis angewandte Mechanik GmbH, Kriens (CH)

(72) Inventor: Georges Marie Mandanis, Kriens (CH)

(21) Appl. No.: 19/390,728

(22) Filed: Nov. 17, 2025

(30) Foreign Application Priority Data
Nov. 19, 2024 (EP) 24214003.6

(51) Int. Cl. B63H 16/04; G01L 1/22

(52) U.S. Cl. CPC B63H 16/04; G01L 1/22

(57) ABSTRACT

A system for an oar for determining the rowing force during an oar stroke of a rower in the water has a measurement receiver with an oar shaft-side receiving area for attachment to an oar shaft of an oar and with an oar grip-side receiving area for attachment to an oar grip of this oar. A plate is provided between the receiving areas, on both sides of which a strain gauge is applied near the oar shaft-side receiving area or near the oar grip-side receiving area , the signal from which can be used to determine the rowing force, since when force is exerted on the oar grip-side receiving area perpendicular to the plane of the plate, the plate assumes an S-shape.

### CROSS-REFERENCE TO RELATED APPLICATION

This application claims priority to European Patent Application No. 24214003.6 filed November 19, 2024, the disclosure of which is hereby incorporated by reference in its entirety.

### BACKGROUND OF THE INVENTION

### FIELD OF THE INVENTION

The present invention relates to a system for an oar for determining the rowing force during an oar stroke of an oar in the water and an oar with such a system.

### DESCRIPTION OF PRIOR ART

EP 3187849 discloses a system and method of the type mentioned above. This system enables, for example, the monitoring of oar strokes during training or competition by the rower himself or by a third party, such as a coach. It allows a detailed analysis of the oar stroke with the aim of improving it. It also allows comparisons with stored values, such as those from a previous series of measurements, for example from a previous training session or race, or allows a comparison with other rowers, for example a teammate or a world champion. These comparisons help the rower or coach to better assess the performance of the individual rower and thus put together a targeted training program. The system is also suitable for recreational rowers, as it makes their own performance and thus their development visible.

### SUMMARY OF THE INVENTION

The system according to EP 3187849 requires a subdivision of the oar shaft. The system is then inserted at the separation point. One of the objects of the invention is therefore to provide a system in which the installation of the sensors is simplified and which is more reliable, cheaper, or easier to use.

A system for an oar for determining the rowing force during an oar stroke of an oar in the water has a measurement receiver with an oar shaft-side receiving area for attachment to an oar shaft of an oar and with an oar grip-side receiving area for attachment to an oar grip of this oar. At least one strain gauge arranged in the measurement receiver allows an oar force to be determined from its signal, whereby an evaluation circuit connected to the strain gauge or strain gauges is used.

It is essential that the longitudinal axis of the attachment of the measurement receiver on the oar shaft coincides with the longitudinal axis of the attachment of the measurement receiver on the oar grip without load, whereby the measurement receiver then comprises at least one plate extending between the oar shaft-side receiving area and the oar grip-side receiving area, so that when force is exerted on the oar grip-side receiving area perpendicular to the plane of the plate, the plate assumes an S-shape. The invention then provides for two strain gauges, which are applied close to the oar shaft-side receiving area or close to the oar grip-side receiving area on both sides of said plate, wherein the evaluation circuit is configured to calculate the force exerted on the oar grip from the elongation and compression of the two strain gauges.

One advantage of this arrangement is that, in the case of an existing oar, only the oar grip needs to be replaced by an oar grip with the system disclosed here, since all components for measuring the force and rotational movement of the oar can be integrated into it. The only other input required for the evaluation is the distance from the measurement point to the oarlock, which must be determined and used in the evaluation.

Instead of determining the bending moment on an oar during an oar stroke of a rower in the water, the force on the oar grip is measured directly via two strain gauges (also referred to here as SG for short), from whose signals the moment generated can be determined. The stroke rate of the oar, i.e., the number of strokes over time, can also be determined by the system using integrated sensors.

Advantageously, two plates are provided, which are arranged parallel to each other at a radial distance from the longitudinal axis of the oar shaft-side receiving area for attaching the measurement receiver in the direction of the force exertion. This allows the measuring system to be positioned close to the oar grip itself but in the area of the oar shaft end. If the distance from the longitudinal axis of the two plates is the same, the oar shaft end can advantageously be arranged in a sleeve between the plates to allow for longer guidance, in particular over the entire measurement receiver up to the area of the oar grip. For this purpose, an inner part can be provided which is arranged in the measurement receiver between the plates and can be mounted in particular with a thread in a sleeve of the oar grip beyond the plates. In this case, a sleeve tapering as a truncated cone in the direction of the oar grip can form the guide.

In an advantageous system, a microelectromechanical system is also provided for detecting the rotational movement in order to then determine the rowing power via an evaluation circuit with a torque determined from the measured force via a stored distance value of the measurement receiver from the oarlock.

Advantageously, the two measured values determined by the left and right oar can be transmitted to an external evaluation circuit, which then calculates the respective performances. Such an evaluation circuit can be configured as software in a tablet or smartphone.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings:

FIG. 1 shows a side view of an oar with a system according to an embodiment of the invention;

FIG. 2 shows a perspective view of the oar grip of the oar according to FIG. 1 with the system without a covering housing and without an inner part, viewed obliquely from above;

FIG. 3 shows another perspective view of the oar grip similar to FIG. 2, viewed obliquely from below;

FIG. 4 shows a side view of an inner part for mounting the oar shaft;

FIG. 5 shows a side view of a part of an oar grip in relation to the inner part according to FIG. 4;

FIG. 6 shows a side view of the oar grip in the rest position and a side view after pulling the oar grip in the direction of pull; and

FIG. 7 shows a diagram of the measured force over time for a system arranged on the port side and on the starboard side in an oar grip according to an embodiment.

### DESCRIPTION OF THE INVENTION

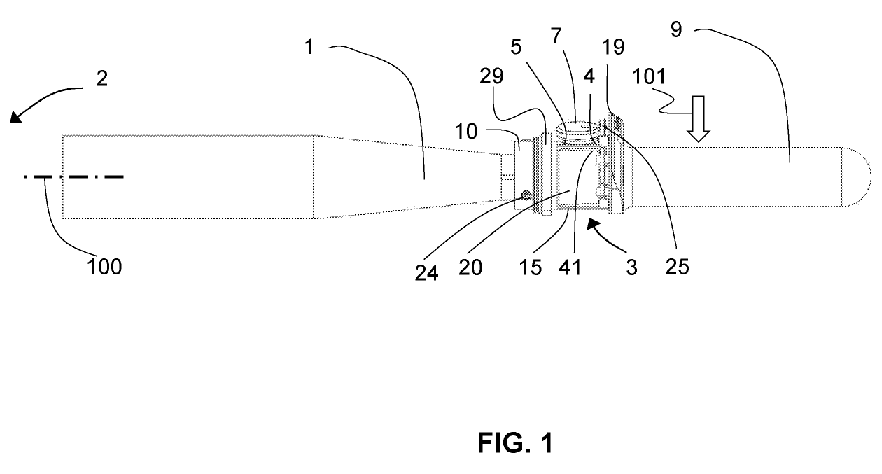

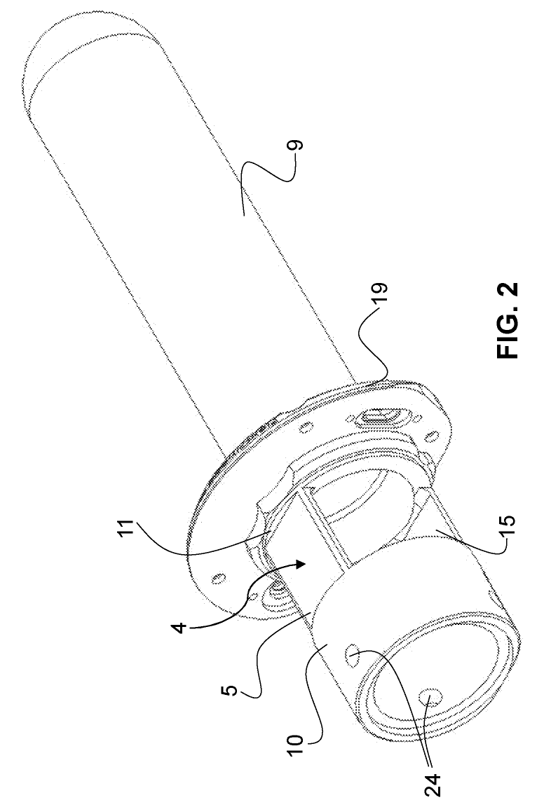

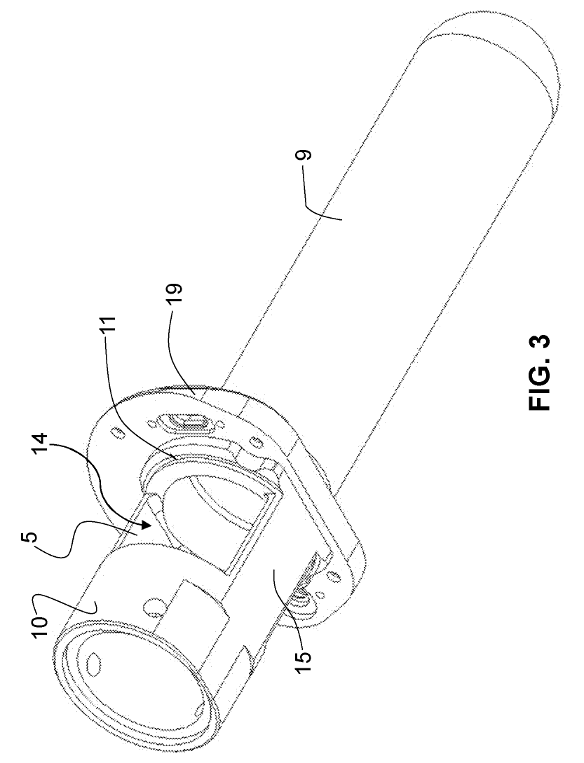

FIGS. 1, 2, and 3 should be viewed together. FIG. 1 shows a side view of an oar with a system according to an embodiment of the invention. FIG. 2 shows a perspective view of the oar grip 9 from FIG. 1 with the system without showing electronic components, without a covering housing and without inner part 20, viewed obliquely from above. FIG. 3 shows another perspective view of the oar grip 9 similar to FIG. 2, viewed obliquely from below.

FIG. 1 shows a side view of a system according to the invention with an oar with an oar shaft 1, which ends in an oar blade 2 not shown here. The oar also has an oar grip 9 on the side opposite the oar blade. A measurement receiver 3 is arranged between the oar shaft 1 and the oar grip 9, connecting the oar shaft 1 to the oar grip 9.

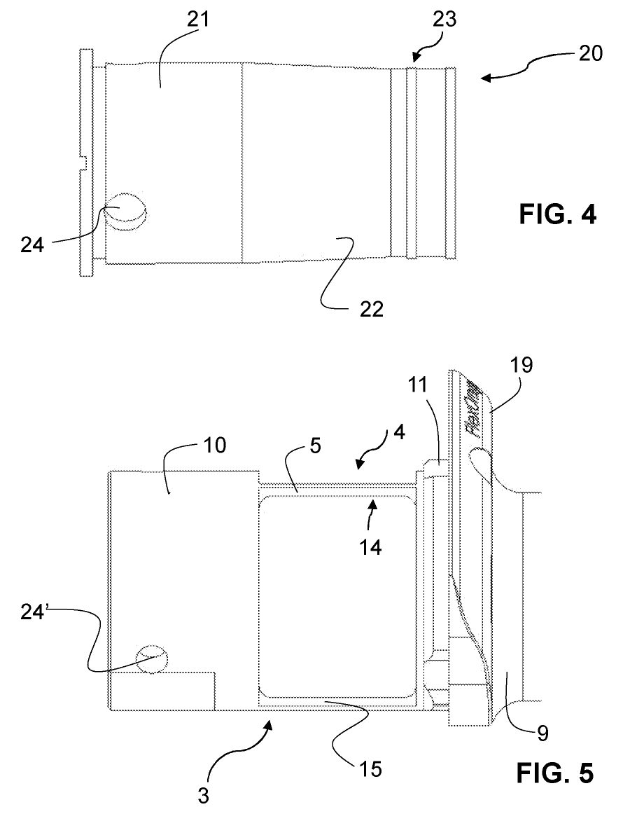

FIG. 1 shows a central inner part 20, for example in the form of a sleeve, which is surrounded on two opposite sides by an upper blade 5 and a lower blade 15. "Upper" refers to the direction opposite to the direction of pull 101 and "lower" refers to the direction of pull. The two blades 5 and 15 are thin plates. The blades 5 and 15 are connected to the measurement receiver 3 on the left, i.e., on the oar shaft side. The blades 15 are also connected to the measurement receiver 3 on the right, i.e., on the oar grip side. The thin plates 5, 15 are arranged parallel to each other without load and aligned perpendicular to the direction of pull 101. Each of the plates 5, 15 reacts like a beam clamped on both sides. The measurement receiver 3 has a sleeve at both ends of the thin plates 5 and 15 for attachment to the oar shaft 1 and the oar grip 9, respectively. Advantageously, a processing unit and an energy source, for example an accumulator or a battery 7, are arranged radially outside the upper blade 5, above its outer side on a PCB 25. The processing unit may also be contained in the PCB 25. If the inner part 20, which is shown in more detail later in FIG. 4, does not have a truncated cone section 22 and thus the end area of the sleeve 23 already ends at the end of the outer thread 21, both the PCB 25 and the battery 7 could be arranged inside the hollow oar shaft 1 or in the oar grip 9. The PCB 25 is attached here to the stop 19 of the oar grip 9, which is designed as a flange. The reference numeral 29 denotes the seal arranged as a sealing ring 29 on the outer jacket of the oar shaft-side sleeve 10. This seal is usually connected to a housing (not shown in the figures) around the measurement receiver 3. The housing can then be attached to the flange 19 on the other side. This allows the entire measurement receiver to be positioned in a sealed manner.

Both the oar shaft-side sleeve 10 and the oar grip-side sleeve 11, as well as the web-shaped connection between them via the blades 5 and 15, can be conceptually assigned to the oar grip 9, as they form a single-piece connection.

An outer strain gauge 4 is attached to the upper blade 5 on the surface facing away from the axis 100 and thus from the lower blade 15, and an inner strain gauge 14 is also attached to the upper blade 5 on the surface facing the axis 100 and thus the lower blade 15. The inner strain gauge 14 is thus arranged close to but at a distance outside the inner part 20. Both blades 5 and 15 are advantageously arranged at the same distance from the central longitudinal axis of the oar grip 9 without load on the oar grip 9.

FIG. 4 shows a side view of an inner part 20 for mounting the oar shaft 1, while FIG. 5 comprises a side view of a part of an oar grip 9 arranged directly below it in relation to this inner part 20 according to FIG. 4. When assembled, the inner part 20 is inserted and fixed in the measurement receiver 3 arranged in or in front of the oar grip 9. For this purpose, the inner part 20 has an outer thread 21 in its sleeve-shaped end on the oar shaft side, opposite which there is an internal thread provided in the oar shaft-side sleeve 10, so that the inner part can be screwed in when inserted. In principle, other locking methods can also be used. The advantage of the inner part 20 as a sleeve is the longer guide for the oar shaft 1, which extends through the sleeve, i.e., within the area with the outer thread 21 and the truncated cone-shaped sleeve section 22 between the blades 5 and 15, into the end area 23 of the inner part 20.

Both elements, the inner part 20 and the measurement receiver 3 of the oar grip 9, are aluminum parts that form the supporting structure. Only the thin plates 5 and 15 connect this oar shaft-side sleeve 10 to the oar grip 9. The inner part 20 has a slightly tapered truncated cone section 22 at the section 21 with the outer thread, so that the oar grip-side sleeve 11 can move in the direction of pull 101 of the oar attached to a boat. Reference numerals 4 and 14 mark the positions at which the strain gauges are attached to the upper blade 5 in the direction of the web, facing outwards and inwards. Alternatively, the strain gauges can also be attached to the lower blade 15 in the same way, facing outwards and inwards.

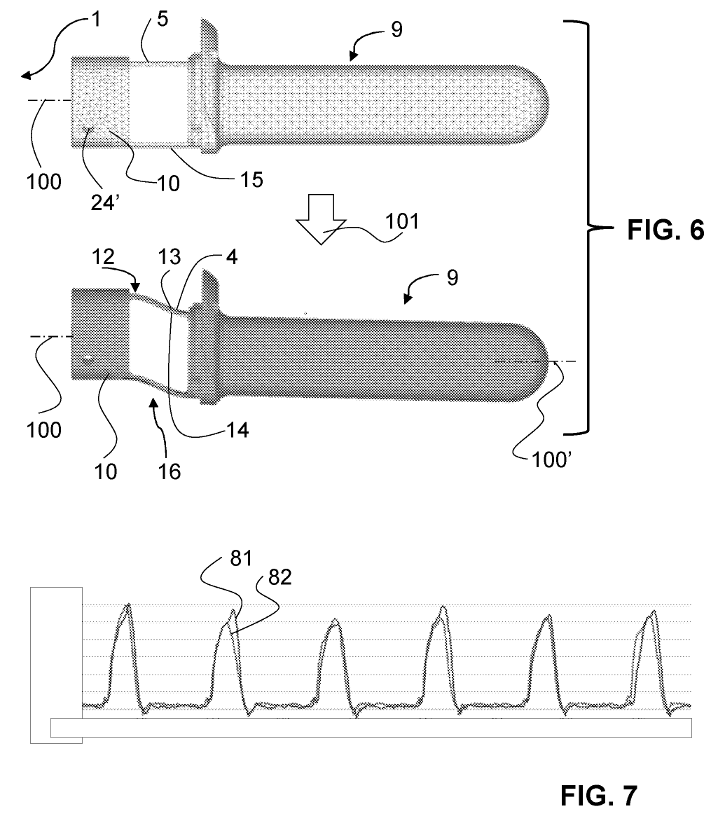

FIG. 6 shows a side view of the oar grip 9 in its rest position and after being pulled on the oar grip 9 in the direction of pull 101. Other elements of the oar are not shown. These are connected to the oar shaft-side sleeve 10. This is connected to the oar shaft around the longitudinal axis 100 of the oar (without load). This longitudinal axis 100 is also the longitudinal axis 100 of the grip 9 in the rest position.

The sleeve part 10, which is connected to the blades 5, 15 with the oar grip 9, and the inner part 20 (not shown in FIG. 6), which is firmly connected via the outer thread 21 on the inner part 20 to a corresponding internal thread of the sleeve part 10, are the only elements connected to the oar shaft 1; otherwise, the inner part 20 is not in contact with the oar grip. The oar shaft 1 is guided into the inner part 20 without play and fixed with three screws (not shown) in corresponding fixation holes 24' in the measurement receiver 3 and through-holes 24 in the inner part 20. This design ensures a firm, non-restrictive connection between the oar grip 9 and the oar shaft 1 with a long guide path over the length of the inner part 20, which cannot be loosened during rowing.

The measuring elements are two strain gauges (SG) 4 and 14, which are glued to the upper blade 5 of the oar grip 9 opposite each other. The two SG 4 and 14 must be positioned exactly on top of each other and symmetrically opposite the vertical plane of symmetry.

The strain gauges measure the force exerted by the rower on the oar grip 9. When this measured force is multiplied by the distance between the oar grip and the oarlock, the corresponding moment is obtained.

The force applied in the direction of pull 101 causes the upper blade 5 and the lower blade 15 to deform into an S-shape. This S-shaped deformation 16 occurs at the clamping points of the blades 5 or 15; thus the oar shaft-side receiving area 12 and the oar grip-side receiving area 13 form the suitable areas for attaching, in particular gluing, the strain gauges 4 and 14 on opposite sides of the blades 5 or 15. In other words, there are four possibilities for mounting the strain gauges. Usually only one is used. However, for redundancy reasons and to increase measurement accuracy through two independent measurements, it is also possible to use two pairs of strain gauges, for example on both blades 5 and 15.

The oar grip 9 is moved by the rower's pull in direction 101, i.e., perpendicular to the longitudinal axis 100 of the oar (without load). This movement can have a maximum stroke of approximately 0.1 millimeters, for example. This is not a pivoting movement of the oar grip 9, but rather a translational or lateral movement that leads to a displacement (offset) of the longitudinal axis 100' of the grip 9 under load. The oar's pull causes the oar grip to deform by bending blades 5 and 15 at the clamping points, resulting in the aforementioned S-shape 16.

The processing unit 50 is connected to the two strain gauges 4 and 14, which measure the difference in elongation between the upper and lower sides of the upper blade 5. As already explained above, this measurement can also be taken on the lower blade 15 and on the oar shaft-side receiving area 12, although measurement by strain gauge on the oar grip-side mounting area 13 is preferred. This difference is greatest at the clamping points on the left and right and zero in the middle between the two clamping points. This is a turning point, i.e., there is no curvature and no difference in elongation. For this reason, the strain gauges must be located as close as possible to one or more of the clamping points.

This measurement only responds to the force. The moment generated by the force is transferred by a pull force in the cross-section of the upper blade 5 and by a compressive force in the cross-section of the lower blade 15. Both strain gauges 4 and 14 on a blade 5 or 15 produce the same signal for this load, i.e., the difference remains zero. This strain gauge arrangement therefore actually measures only the force and not the moment.

The invention is based, inter alia, on the fact that it is possible to measure the force on a double-clamped flexible blade in order to determine the rowing power. Advantageously, a second blade is provided on the opposite side of the longitudinal axis of the grip in order to guide the free end of the oar shaft 1 in the inner part 20 up to the oar grip area. Advantageously, a further sensor is provided for determining the rotational speed of the oar, whereby two measured values can be determined, namely force and rotational speed; both measured over time in order to determine the desired magnitude of the rowing power. In doing so, it is essential for determining the value that one works over time intervals of an oar stroke and is not interested in the force alone or the moment. This is because moment and rotational speed are measured in parallel over time at the same location, namely in and near the measuring bridge of the two strain gauges 4 and 14. To do this, the torque and rotational speed must be measured at the oarlock, whereby the measured force is multiplied by the distance from the oarlock by the measuring bridge in order to determine the torque.

Preferably, the oar grip is essentially cylindrical with a central axis 100. Since the oar shaft 1 generally has an essentially circular cross-section, a cylindrical shape is suitable as a connecting element with two flat opposing blades 5 and 15. Alternatively, measuring sleeves with oval or polygonal cross-sections, such as rectangular, square, or hexagonal cross-sections, can be used, as long as the two blades 5 and 15 are configured so that the oar's pull on the oar grip is applied in the direction 101 perpendicular to the arrangement of the blades 5 and 15. The greatest strains can be measured at these contact surfaces due to the direction of the force applied to the oar blade, i.e., essentially perpendicular to the oar blade.

FIG. 7 shows a diagram of the measured force 81 or 82 over time for a system arranged on the port side and on the starboard side in an oar grip 9 according to an embodiment of the invention. Advantageously, the two measured values determined by the left and right oars are transmitted to an external evaluation circuit, which then calculates the respective performances. Such an evaluation circuit can be configured as software in a tablet or smartphone. It makes sense for the data transmission to take place via a radio link, for example via a Bluetooth connection.

### LIST OF REFERENCE SIGNS

1 oar shaft

2 oar blade

3 measurement receiver

4 outer strain gauge (SG)

5 upper blade

7 battery

9 oar grip

10 oar shaft-side sleeve

11 oar grip-side sleeve

12 oar shaft-side receiving area

13 oar grip-side receiving area

14 inner strain gauge (SG)

15 lower blade

16 S-shaped deformed blade

19 flange / stop (for the oar grip)

20 inner part

21 outer thread of the inner part

22 tapering hollow truncated cone section

23 end area of the sleeve 20

24 through-hole

24 fixation hole

25 PCB

29 sealing ring

50 processing unit

81 bending moment curve starboard

82 bending moment curve port side

100 longitudinal axis of the oar (without load)

100 longitudinal axis of the grip (under load)

101 direction of pull

1. A system for an oar for determining the rowing force during an oar stroke of an oar in the water, comprising:
a measurement receiver with an oar shaft-side receiving area for attachment to an oar shaft of an oar and with an oar grip-side receiving area for attachment to an oar grip of this oar;
at least one strain gauge arranged in the measurement receiver, from whose signal a force can be determined; and
an evaluation circuit connected to the strain gauge or strain gauges;
wherein the longitudinal axis of the attachment of the measurement receiver to the oar shaft coincides with the longitudinal axis of the attachment of the measurement receiver to the oar grip without load, wherein the measurement receiver comprises at least one plate which extends between the oar shaft-side receiving area and the oar grip-side receiving area, so that when a force is exerted on the oar grip-side receiving area perpendicular to the plane of the plate, the plate assumes an S-shape, wherein two strain gauges are provided, which are applied close to the oar shaft-side receiving area or close to the oar grip-side receiving area on both sides of the plate on both sides of the plate, and wherein the evaluation circuit is configured to calculate the force exerted on the oar grip from the elongation and compression of the two strain gauges.

2. The system according to claim 1, wherein two plates are provided, which are arranged parallel to each other at a radial distance from the longitudinal axis of the oar shaft-side receiving area for fastening the measurement receiver in the direction of force exertion.

3. The system according to claim 2, wherein the two plates are arranged opposite each other at the same radial distance from the longitudinal axis.

4. The system according to claim 3, wherein an inner part is provided, which is arranged in the measurement receiver between the two plates, and which inner part is fixed to the oar shaft-side receiving area.

5. The system according to claim 4, wherein the inner par has an outer thread which can be screwed into an internal thread of the oar shaft-side receiving area, wherein the inner part extends into the oar grip.

6. The system according to claim 5, wherein the inner part has a tapered hollow truncated cone shape in the direction of the oar grip for guidingly receiving the oar shaft.

7. The system according to claim 1, in that a microelectromechanical system is arranged in such a way as to determine the rotational movement of the system about an axis perpendicular both to the longitudinal axis of the oar shaft-side receiving area and perpendicular to the plane of the plate(s) or direction of force application over time, and in that the evaluation circuit is configured to maintain the predetermined distance of the axis of rotation from the oar grip and is further configured to determine the rowing power over time from the scalar product of the force with the predetermined distance of the axis of rotation from the oar grip and the rotational movement.

8. The system according to claim 7, wherein the values of the rotational movement and the detected force are transmitted to the evaluation circuit, which is located in a device external to the oar.

9. An oar for determining the rowing force during an oar stroke of a rower in the water, comprising:
an oar grip;
an oar shaft extending away from the oar grip;
a system according to claim 1.
